(19) United States
(12) Patent Application Publication
(10) Pub. No.: US 2014/0131280 A1
(43) Pub. Date: May 15, 2014

(54) PROCESS FOR WORKING UP MINE WATERS

(71) Applicant: SIEMENS AKTIENGESELLSCHAFT, Munich (DE)

(72) Inventors: Roland Haseneder, Freiberg (DE); Georg Härtel, Freiberg (DE); Andre Rieger, Freiberg (DE); Paul Steinberger, Hamburg (DE)

(73) Assignee: SIEMENS AKTIENGESELLSCHAFT, Munich (DE)

(21) Appl. No.: 14/128,760

(22) PCT Filed: Jun. 1, 2012
(86) PCT No.: PCT/EP2012/060419

§ 371 Date: Dec. 23, 2013

(30) Foreign Application Priority Data
Jun. 22, 2011 (EP) 11171007.5

(51) Int. Cl. C02F 9/00

(52) U.S. Cl. CPC C02F 9/00
USPC 210/638; 210/712

(57) ABSTRACT

In a process for mine waters, a hardness-free, alkaline reagent is first added at least once to the mine water that is to be worked up, whereby metals are sedimented or precipitated out as hydroxides from the mine water that is to be worked up. The precipitated metal hydroxides are separated off and the remaining mine water is further treated by adding a hardness-forming precipitation reagent, whereby gypsum, in particular in the form of gypsum mud, is precipitated out from the then metal-free mine water that is to be worked up. Thus a sequential separation of the metals and the sulphate from the mine water that is to be worked up proceed via corresponding precipitation using respectively corresponding precipitation chemicals, wherein, in the gypsum precipitation following the metal precipitation, a metal-free gypsum mud is produced that is safe to landfill.

### CROSS REFERENCE TO RELATED APPLICATIONS

This application is based on and hereby claims priority to International Application No. PCT/EP2012/060419 filed on Jun. 1, 2012 and European Application No. 11171007.5 filed on Jun. 22, 2011, the contents of which are hereby incorporated by reference.

### BACKGROUND

The invention relates to a method for working up mine waters.

In the mining industry, a wide variety of process and conditioning waters accumulate in a great diversity of treatment processes, e.g. during grinding or flotation of the extracted rock, or during beneficiation of the material. These contain not only gangue but also chemicals which are added during treatment and are currently transferred to storage facilities in large quantities.

Because of ongoing chemical reactions, the pH in the stored process and conditioning waters decreases over time and metal ions that can be toxic are released from the gangue and accumulate in the liquid phase.

In addition, an effluent flow composed of waste water from active and already abandoned deep and open pit mines on the one hand and seepage water from treatment residues, spoil and other mineral wastes on the other must be taken into account. This effluent flow is characterized by a low pH value and a high sulfate content and contains dissolved metals of different kinds.

The effluent flow is therefore also termed acid mine drainage (AMD) or acid rock drainage (ARD).

Oxidation produces sulfidic minerals caused by infiltration with surface water, groundwater and oxygen from the air, and also by the activity of sulfide-oxidizing bacteria such as acidithiobactillus ferrooxidans and acidithiobactillus thiooxidans.

For simplicity, the process and conditioning waters before and during storage and the effluent flow will hereinafter be referred to as mine waters, either individually or mixed with one another. Also included in this definition of mine waters are mine waters concentrated using other methods such as membrane filtration, for example.

Because of ever increasing fresh water prices and a growing awareness of the risk to the environment posed by such mine waters, e.g. in respect of pollution of surface and groundwater, the subject of mine water purification and re-use as a fresh and/or industrial water source is becoming increasingly important.

Various active and passive technologies for treating mine water are already well-known.

In a method known as “lime treatment” for treating mine waters, a lime-containing reagent as limestone or slaked lime, e.g. in the form of milk of lime, i.e. lime hydrate mixed with water to produce the consistency of milk, is added to the mine waters to be treated (lime/gypsum precipitation).

This causes sulfate minerals, particularly in the form of gypsum, and mixed minerals containing hydroxide metal compounds or hydroxysulfatic metal compounds to be precipitated.

Said lime treatment requires large quantities of limestone or slaked lime which reduces the economic efficiency of this method. As the dissolved metals are also co-precipitated as hydroxides during gypsum precipitation, a mixed sludge is produced which causes increased disposal costs. There is also the risk here of metal remobilization, as the metals are precipitated as hydroxidic or hydroxysulfatic mixed minerals which can be remobilized.

In the paper “Mine water treatment by membrane filtration processes—Experimental investigations on applicability”, by A. Rieger et al., presented at the conference on membranes in drinking water production and wastewater treatment 20.-22.10.2008 in Toulouse, France, see “Desalination and Water Treatment”, 6 (2009)54-60, www.deswater.com, the following are described as preferred treatment methods:

First, mine water treatment by aeration with the subsequent addition of an alkaline substance such as lime, limestone, caustic soda solution or fly ash is described. This causes metal hydroxides and mineral phases in the form of gypsum to be precipitated from the mine waters. The precipitates are sedimented or filtered, resulting in large quantities of sludge that has to be disposed of. The treated water contains large amounts of sulfates, making it impossible for it to be immediately re-used or discharged into a wastewater system.

Second, biological mine water treatment by sulfate-reducing bacteria using anaerobic constructed or natural wetlands is described. The purifying effect of said constructed or natural wetlands is based on sulfate reduction to sulfide by microorganisms and the associated precipitation of metal sulfides. This is an inexpensive but slow process, which means that this treatment method only achieves satisfactory degrees of degradation with high residence times and consequently a high surface area requirement. There is no recovery or re-use of the water contained in the mine waters.

Mine water treatment by membrane filtration, particularly nanofiltration or reverse osmosis, is also proposed. These are filter processes which take place under pressure, wherein a mine water feed stream is split into two component streams.

The first component stream formed is the so-called permeate, here in the form of most of the water from the feed stream passing through the semipermeable membrane. The permeate constitutes a low-mineral-content process water with high pH usually in the range of approximately pH=4 to 5. In this form—possibly taking relevant legislation or regulations such as local wastewater regulations in particular into account—it can be discharged into the environment, e.g. into a running watercourse or used utility water.

However, the permeate is preferably neutralized and/or mixed with other waters, e.g. fresh utility water, and diluted so that it can be re-used as process water.

The second component stream is the concentrate which comprises a small residual portion of the water basically containing the pollutants present in the feed stream.

DE 103 24 984 A1 describes a treatment of a body of water acidified by mining activities. DE 103 24 984 A1 proposes that, in a first stage, for initial neutralization, sodium hydroxide added in a volume- and acid-potential-dependent manner be introduced into the acidified water until the pH in the acidified water exceeds a limit value in the range 4.3 to 7.0. In a second stage, according to DE 103 24 984 A1, exclusively or additionally calcined dolomite or sodium carbonate (soda ash) shall then be introduced into the acidified water at a pH of 4.3 to 8.2 until the pH and/or a buffering capacity in the form of the Ks4.3 value exceeds a predefined limit value for the pH in the range 5.5-8.2 and for the Ks 4.3 value in the range 0.2 to 3 mmol/1.

### SUMMARY

One potential object is to provide an efficient method for the industrial working up of mine waters from mining operations.

The inventors propose a method for working up mine waters in which a zero-hardness, alkaline reagent (zero-hardness metal precipitation chemical or just metal precipitation chemical) is first added at least once to a mine water to be worked up. This produces a mixed concentrate from which metals—present in the mine water—are precipitated or sedimented as hydroxides (metal precipitation).

Such metals are in particular aluminum, cobalt, copper, iron, nickel, lead and zinc which can be precipitated as corresponding hydroxides. However, in terms of solubility the amphoteric character of metals must be noted.

Thus, in terms of pH-dependent solubility, metals such as zinc and aluminum exhibit ranges in which the metal ions immobilized as hydroxides can be remobilized.

For this purpose the mixed concentrate can be transferred to a settling tank in which the precipitated metal hydroxide sediments as a metal sludge.

The overflow water of the settling tank, i.e. the metal-free mine water after metal precipitation, can be collected and re-used.

A zero-hardness, alkaline reagent is to be understood as meaning any lye which contains no hardness constituent such as magnesium and/or calcium. For example, a zero-hardness, alkaline reagent of this kind can be a caustic soda solution or caustic potash solution.

According to the proposal, a hardness-producing precipitation chemical such as a lime-containing reagent/chemical, e.g. as a lime-containing suspension, in particular as a lime suspension or a slaked lime suspension e.g. in the form of a milk of lime, is then (i.e. after metal precipitation) added to the now metal-free mine water to be worked up. The hardness-producing precipitation chemical can also be a magnesium compound or calcium/magnesium blend.

This produces another mixed concentrate from which gypsum, particularly in the form of gypsum sludge, is precipitated (gypsum precipitation/sulfate precipitation).

For this purpose the mixed concentrate can once again be transferred to (another) settling tank in which the precipitated gypsum is sedimented as gypsum sludge.

Said precipitated gypsum or rather the precipitated gypsum sludge is largely present in pure form, i.e. it is metal-free because of the previously performed metal precipitation, and can in particular be re-used as unpolluted filler material, e.g. in mining operations, or disposed of elsewhere.

The overflow water of the other settling tank, i.e. the mine water after gypsum precipitation, can also be collected and likewise re-used.

Thus—possibly after further processing has been carried out—it can be mixed with mine waters still to be worked up and/or separated off as fresh water and/or also re-used for recovering process solutions, particularly the zero-hardness metal precipitation reagents or metal precipitation chemicals.

In simplified terms, the proposed method allows sequential separation of the metals and sulfate by respective precipitation using appropriate precipitation chemicals (zero-hardness metal precipitation chemicals and hardness-producing precipitation chemicals).

The metals are first precipitated as hydroxides (Me(OH)n) according to equation (1) by adding the zero-hardness, alkaline reagent, and then the sulfate is precipitated as gypsum (CaSO₄.2H₂O) according to equation (2) by adding the hardness-producing or more specifically lime-containing reagent, particularly as a lime-containing suspension.

Meⁿ⁺(aq)+nNaOH [symbol] Me(OH)ₙ←+Na⁺(aq) Equation (1):

SO₄²⁻(aq)+Ca(OH)₂(aq) [symbol] CaSO₄×2H₂O←+2OH⁻(aq) Equation (2):

Clearly, the proposal is based on the insight that, by sequential precipitation, i.e. initial metal precipitation with subsequent gypsum or rather sulfate precipitation for the mine water to be worked up, co-precipitation of the metals, as occurs for example during lime treatment, is avoided.

According to the proposal, sulfate precipitation yields a virtually pure gypsum sludge which can be disposed of inexpensively as compared to gypsum sludge polluted with metals as occurs e.g. during lime treatment.

The consumption of the precipitation chemicals, such as zero-hardness, alkaline and hardness-producing reagent, depends on the composition of the mine water to be worked up and the solubility equilibrium of the component to be precipitated.

The solubility equilibrium describes, according to equation (3), using the temperature-dependent solubility product K_{L}^{i,j} (a,T) and the activity (concentration measure) a, the maximum soluble quantity of dissociable ions i and j until precipitation of the salt [i]⁺[j]⁻ occurs.

For metals in particular, the speciation of the metal ion, the pH value and the redox potential are likewise relevant. In addition, the solubility equilibrium indicates the theoretically necessary quantity of precipitation chemical.

K_{L}^{i,j}(a,T)=aᵢ×aⱼ Equation (3):

If equation (3) is transferred to the applications, i.e. the metal and gypsum precipitation, according to equations (1) and (2), equation (4) is obtained for the metal precipitation and equation (5) for the gypsum precipitation:

K_{L}^{Me(OH)n}(a,T)=a_{ME}ⁿ⁺×aⁿ_{OH-} Equation (4):

K_{L}^{CaSO}₄(a,T)=a_{Ca}2+×a_{SO}_{₄}_{²} Equation (5):

The selectivity of the metal precipitation is achieved by adjusting the pH in the mine water to be worked up. The formal relationship is obtained by logarithmizing equation (3) and substituting the pOH by (pH+pOH=pK_{W} (temperature-dependent ion product (under standard conditions value 14)) to produce equation (6):

pK_{L}^{ME}(OH)ₙ(a,T)=log₁₀a_{ME}ⁿ⁺+n log₁₀a_{ME}ⁿ⁺−n×(14−pH) Equation (6):

From this, by solving equation (6) for pH or rather for the (target) pH value, the quantity of zero-hardness, alkaline reagent required to set this pH or rather the (target) pH value can now be calculated in order to precipitate selected metals in each case.

To determine the precipitation chemical requirement, the neutralization requirement until attainment of the precipitation pH and the precipitation requirement must be calculated.

The neutralization requirement (NB) results from the difference between the current pH of the solution and the precipitation pH of the metal hydroxide in question:

Δa_{OH}_{^{−}}_{,NB}=10^{-(pK}^{_{W}}^{pOH}) Equation (7):

By multiplication by the water volume to be neutralized V_{MW}, the determined activity difference Δa_{OH}_{^{−}}_{,NB} for achieving the precipitation pH value yields the amount of substance of hydroxide ions to be added.

For example, in the case of known activity a_{NaOH} of a caustic soda solution used, the amount of caustic soda solution required for neutralization can be theoretically calculated.

A safety margin S is usual, as reality rarely corresponds to theory. Deviations result, among other things, from the fact that the precise composition is rarely known and secondary reactions occur.

$${V}_{NaOH , NB} = S \frac{{V}_{MW} Δ {a}_{{OH}^{-} NB}}{{a}_{NaOH}} {10}_{w}^{- ( pK - pOH )} \frac{S {V}_{MW}}{{a}_{NaOH}} \qquad Equation ( 8 )$$

The precipitation requirement (FB) results from me stoichiometry of equation (1) for the corresponding type of metal ion. For a metal ion Meⁿ⁻, n hydroxide ions are required for formation of the metal hydroxide (and therefore precipitation as metal hydroxide ions). If the activity of the metal in question is known, the activity difference for precipitation can be theoretically calculated as follows:

Δa_{OH}_{^{−}}_{,FB}=na_{ME}_{⁺} Equation (9):

If the activity of the lye is known, the necessary volume of lye can be calculated as follows:

$${V}_{NaOH , FB} = S \frac{{V}_{MW} Δ {a}_{{OH}^{-} FB}}{{a}_{NaOH}} = S {V}_{MW} n \frac{{A}_{{ME}^{+}}}{{a}_{NaOH}} \qquad Equation ( 10 )$$

Once again it is advisable to introduce a safety factor. On the one hand, determining the activity of the metal to be precipitated is laborious and determining the concentration is resorted to. In addition, an analytical determination is always prone to error. Moreover, the metals are not precipitated as hydroxides but as often more complex blends having a higher or lower hydroxide ion requirement. In particular cases, the requirement must be calculated by experimental tests.

The total requirement of a precipitation stage for a type of metal results from the sum of the neutralization and precipitation requirement of the individual stages.

The quantity of hardness-producing precipitation chemical—here shown for a lime-containing suspension but not limited thereto—is dependent on the Ca activity of the suspension and on the sulfate content of the water to be treated. The theoretically possible soluble sulfate or more specifically gypsum quantity follows from equation (2).

As Ca²⁺ and SO₄²⁻ in the gypsum are present in the stoichiometric ratio (1:1), the maximum soluble sulfate quantity is given by:

a_{SO}_{⁴}2−_{,KL}=√K_{L,CaSO}_{₄}_{2H}_{₂}_{O} Equation (11):

The activity of the sulfate of the water to be treated is known from analytical tests and it follows that the sulfate quantity can be reduced according to the gypsum equilibrium by the activity difference

Δa_{SO4}2−=a_{SO}_{⁴}2−_{,MW}−a_{SO}_{⁴}2−_{KL}. Equation (12):

The necessary quantity of Ca²⁺ required for precipitation coincides with the activity difference. If the Ca activity of the suspension is known, the volume of milk of lime suspension to be added can be calculated as:

$${V}_{Ca ( OH ) 2 , FB} = S \frac{{V}_{MW} Δ {a}_{{SO}_{4}} {2}_{-}}{{a}_{Ca ( OH ) 2}} \qquad Equation ( 13 )$$

Again an allowance factor S is also introduced here which allows for secondary reactions, analytical accuracy and the use of concentrations instead of activities. Once again it should be noted here that the precipitation of gypsum is a great simplification. Other compounds are always precipitated also depending on the composition of the mine water to be treated.

With the adding of the milk of lime suspension, the pH is increased still further. Because of the stoichiometry of Ca(OH)₂, the quantity of hydroxide ions added from the introduction of the milk of lime in the sulfate precipitation corresponds to:

Δa_{(OH)-}=2Δa_{SO}2− Equation (14):

In other words, the pH after gypsum precipitation (GF) compared to the pH of the last metal precipitation stage (MF) assumes the following theoretical value.

pH_{GF}=pH_{MF}+Ig(Δa_{OH-})=pH_{MF}+Ig(2Δa_{SO}_{⁴}2−) Equation (15):

The hydroxide ions additionally added here are then recovered together with the cations (for NaOH therefore e.g. Na⁺) added with the zero-hardness lye in the following NF stage.

If “complete” recovery is to be achieved, it is necessary in some cases to charge more Ca(OH)₂ than is necessary for gypsum precipitation. However, this must be determined in particular cases and depends on the composition of the water to be treated.

These metals precipitated as metal hydroxides can be re-used, enabling them to be preferably sold to the industry as valuable resources.

Another advantage of the proposed methods is that—because of the initially precipitated metals or rather the absence of metals in the mine water to be worked up following metal precipitation—the formation of hydroxidic metal compounds during subsequent gypsum precipitation is ruled out. Remobilization of metals, as can occur in the gypsum sludge during the known lime treatment, is eliminated.

Metal precipitation can preferably take place in a single step. Here, by “once-only” precipitation by once-added precipitation chemical, i.e. of the zero-hardness, alkaline reagent, e.g. sodium hydroxide or caustic potash solution, all the metals can be precipitated, i.e. separated off, in one step. However, it must be noted that metals having amphoteric character in this range may go back into solution.

To achieve this, metal precipitation takes place at a predefinable or rather adjustable pH or rather pH value range, e.g. of around or more than 8, enabling all the metals to be precipitated simultaneously.

This pH or rather pH value range is adjusted by appropriate addition or rather the addition of an appropriate quantity of (metal) precipitation chemical.

Alternatively, metal precipitation can also take place in a plurality of sequential steps. Here, metals are separated off—selectively—by fractionated precipitation by multiple additions of appropriate amounts of precipitation chemical, i.e. of the zero-hardness, alkaline reagent, e.g. sodium hydroxide or caustic potash solution, at different pH values or rather in different pH value ranges. The selectivity of metal precipitation is achieved by adjusting the pH.

With particular preference it can be provided that fractionated metal precipitation takes place with increasing pH values/pH value ranges, wherein each pH value/pH value range is selectively adjusted for a particular metal.

Thus it can be provided that, in a first metal precipitation, at a pH of approximately 3.8, iron is precipitated, in a second metal precipitation, at a pH of approximately 4 to 4.5, aluminum is precipitated, and in a third metal precipitation, at a pH of approximately 8, copper is precipitated.

The respective pH value is adjusted by adding the appropriate quantity of precipitation chemical.

Also, the mine water after gypsum precipitation (gypsum precipitation effluent), e.g. as (collected) overflow water of the other settling tank, can be re-used. For example, it can be mixed with as yet untreated mine waters.

Preferably, however, the mine water after gypsum precipitation or rather the gypsum precipitation effluent can be re-used for recovering the process solutions, particularly the zero-hardness metal precipitation reagents/chemicals, wherein—if necessary—separation of unsedimented suspended particles can possibly be performed in advance by multimedia or ultrafiltration.

With particular preference, this recovery of process solutions from the effluent takes place by integration of pressurized membrane methods such as nanofiltration and/or reverse osmosis, thereby achieving a so-called zero liquid discharge mode of operation.

Specifically, the gypsum precipitation effluent can be used to concentrate the sulfate or more specifically the gypsum solution.

In the case of a sulfate concentration of this kind, the mine water after gypsum precipitation can be fed, e.g. by a conveying device, to a membrane filter module for pressurized membrane filtration, particularly nanofiltration, wherein—if necessary—the separation of unsedimented suspended particles can be performed in advance by multimedia or ultrafiltration.

As a result, the membrane- or more specifically nano-filtered mine water is split into two component streams, the permeate and the concentrate.

As a membrane method, nanofiltration is, among other things, selective for the separation of monovalent ions in the permeate and polyvalent ions in the concentrate. The residual sulfate content determined by the solubility equilibrium in the gypsum precipitation effluent is concentrated—in the concentrate—by permeation of the solvent and retention of polyvalent ions in the nanofiltration via the solubility equilibrium and fed back into the gypsum precipitation (recirculated) in which gypsum precipitation is re-initiated.

This enables the use of the hardness-producing or more specifically lime-containing reagent or gypsum precipitation chemical to be reduced—and therefore consequently reducing costs, particularly transportation costs of the gypsum precipitation chemical.

The permeate is an alkaline aqueous solution which is dominated by the monovalent ions of the metal precipitation reagent, e.g. by Na⁺ and OH⁻ ions. Further monovalent ions result from the composition of the mine water to be worked up and reduce the quality of the alkaline aqueous solution as a recoverable or recovered metal precipitation concentrate which can be fed to the metal precipitation after quality-dependent mixing with “fresh” metal precipitation reagent or more specifically fresh zero-hardness, alkaline reagent.

As zero-hardness, alkaline reagents or precipitation chemicals such as the caustic soda solution have hitherto not been used, or used only to a small extent, in the treatment of mine waters to be worked up because of the high costs compared to pure gypsum precipitation, the higher costs thereof can again be offset by recovery of the metal precipitation chemical, particularly of the caustic soda solution.

In order to produce large quantities of permeate, it is preferable for the mine water to be fed to the membrane filter module after gypsum precipitation at a pressure ranging from 10 to 30 bar. The achievable quantities of permeate increase with increasing pressure.

The membrane filter module is particularly designed such that, in order to generate a turbulent flow, the flow direction of the mine waters changes abruptly through 180° at least once as they pass through the membrane filter module. This can take place by an abrupt reversal of the flow direction or by installing swirl elements in the flow path.

Membrane filter modules designed for industrial use are commercially available, e.g. from Pall GmbH, 63303 Dreieich.

According to the manufacturer, they are used for conditioning and softening groundwater, desalinating seawater, filtering and purifying seepage water from landfill sites, filtering and softening surface water, and treating industrial waste and sludge from boilers and cooling towers.

The membrane filter modules available under the designation Pall Disc Tube® are ideally designed to produce a turbulent flow in the fluid flowing through the membrane filter module and are therefore surprisingly also suitable for use in a membrane filter system for working up mine waters in accordance with the further-developed proposed method.

The mine water after gypsum precipitation here flows along parallel, fluidically series-connected disk-shaped membrane filters spaced apart by separating plates and is deflected through 180° in the region of the edges of the membranes, so that a turbulent flow is produced.

The membrane filter module preferably comprises at least one nanofilter membrane. Membranes of the Alfalaval NF99 type have been found to be particularly suitable here.

According to another preferred further development, recovery of the metal precipitation chemical can be further improved by subjecting the permeate of the (first) membrane filtration (concentration of the gypsum solution) to another membrane filtration for concentrating the zero-hardness, alkaline reagent, i.e. the metal precipitation chemical.

For such a concentration of the metal precipitation chemical, the permeate can be fed after or rather from the first membrane or rather nanofiltration, e.g. by a conveying device, to another membrane filter module for pressurized membrane filtration, in particular reverse osmosis.

As a membrane method, reverse osmosis is among other things selective for the separation of monovalent and polyvalent [ions]. The precipitation chemical or rather its (monovalent) ions, e.g. Na⁺and OH⁻, is/are concentrated—in the concentrate—by permeation of the solvent and retention of monovalent ions in the reverse osmosis via the solubility equilibrium and returned to the metal precipitation (recirculated) in which metal precipitation is re-initiated.

With recovery of the zero-hardness, alkaline reagent or rather of the metal precipitation chemical by the concentration thereof, its high costs can again be offset.

After this reverse osmosis, the permeate constitutes fresh water. To achieve drinkable quality, this fresh water must if necessary undergo further treatment in order to comply with the drinking water limit values defined by legislation, particularly local wastewater regulations.

This procedure, particularly also the preferred further developments thereof, therefore allows clean separation of the substances contained in the mine waters into, on the one hand, water of drinkable quality, i.e. fresh water, on the other hand industrially reprocessable metals, and also pure gypsum, so that in each case selective re-use is possible without risk of environmental damage.

The separated fresh water—particularly as reverse osmosis permeate—is used, preferably after neutralization or mixing with utility water, to constitute process and/or conditioning waters in a mining operation producing the mine waters. It can be used, for example, for drilling, milling, grinding, flotation, etc. It can also be re-used as drinkable fresh water.

Preferably, however, the fresh water can be used in turn for forming the lime-containing reagent, particularly the lime-containing suspension, such as the milk of lime, and/or the zero-hardness, alkaline reagent, particularly the sodium hydroxide or caustic potash solution.

Another advantage is that, without such abstraction of the fresh water—particularly as a “pure” reverse osmosis permeate—the settling tank(s) will overflow. Otherwise it would be necessary to “oversize” the settling tank.

The precipitated gypsum or more precisely the precipitated gypsum sludge is largely present in pure form, i.e. due to the previously performed metal precipitation it is metal-free and can in particular be re-used as a filler material e.g. in mining operations, or disposed of elsewhere.

The method can also be further developed such that, by using other precipitation chemicals, other conditioning processes can be covered. Also foreseeable is the use of membrane methods with different separation characteristics, such as ultrafiltration to abstract dissolved organic matter.

By the proposed method, in particular mine waters from mining operations with sulfidic and/or sulfur-containing minerals or ores can be worked up.

For example, the method is particularly suitable for working up acid mine drainage (AMD) or acid rock drainage (ARD) or for working up mine waters concentrated using other methods such as membrane filtration. In other words, the method can not only be used for directly treating mine waters, but can also be used in the treatment of mine water concentrates, e.g. from direct filtration, particularly as the volume flow to be treated is considerably reduced by pre-filtration. Moreover, the increased metal content means greater cost-effectiveness.

The proposed method can also be used in the metalworking industry for conditioning in particular metal-containing and/or sulfidic and/or sulfur-containing wastewaters occurring there.

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 shows a first procedure of a method for working up mine waters,

FIG. 2 shows a second procedure of a method for working up mine waters,

FIG. 3 shows a third procedure of a method for working up mine waters and

FIG. 4 shows a fourth procedure of a method for working up mine waters.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

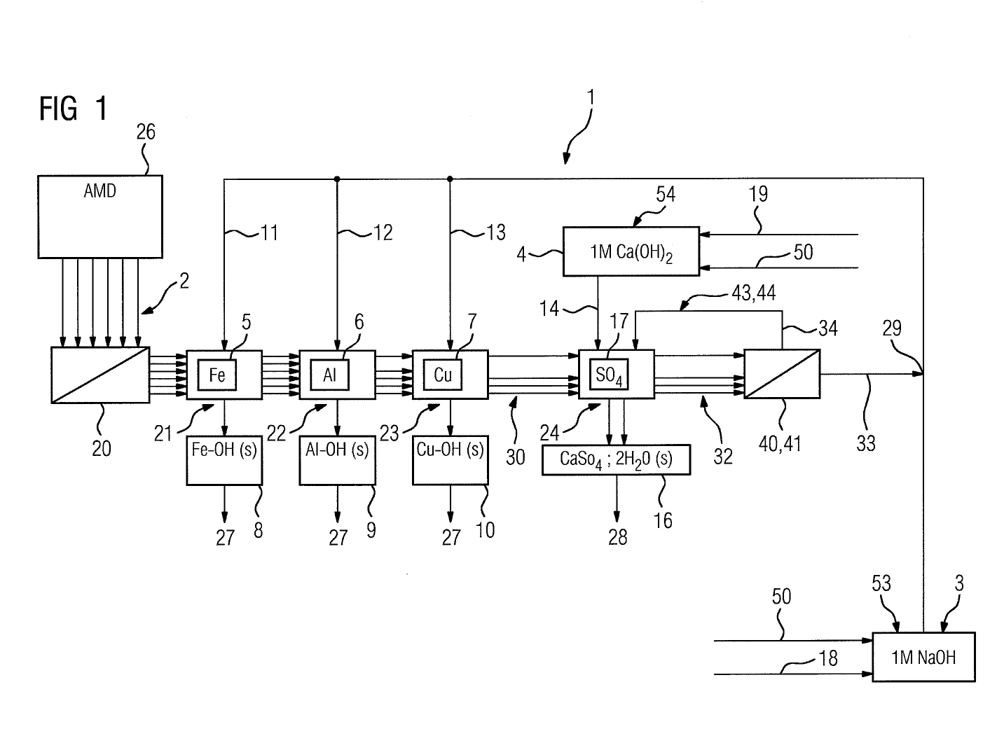

FIG. 1 shows a first procedure 1 of a method for working up mining-influenced mine waters 2 by sequential metal and gypsum precipitation, i.e. according to procedure 1, metal precipitation 21, 22, 23 takes place first, followed—sequentially—by gypsum precipitation 24.

The mining-influenced mine water 2, in this case so-called acid mine drainage (AMD), taken from a tailings pond 26 or directly from a mine (not shown), is conditioned via a microfiltration unit 20 such that it is particle-free.

Metals 5, 6, 7 are then isolated by fractionated precipitation 21, 22, 23 using a precipitation chemical 3, here a zero-hardness, alkaline reagent, specifically here caustic soda solution, at different pH values of the mine water 2 to be worked up (metal precipitation, here as fractionated metal precipitation 21, 22, 23).

Said metal precipitation chemical 3, i.e. the caustic soda solution, is produced 53 by dissolving sodium hydroxide 18 in water 50 and is added 11, 12, 13 to the fractionated precipitation 21, 22, 23.

The fractionated metal precipitation 21, 22, 23 using caustic soda solution 3 takes place as shown in three sequential actions 11, 12, 13/21, 22, 23.

The selectivity of metal precipitation is achieved by adjusting the pH in the mine water 2 to be worked up in the respective fractionation stage. This is effected by adding an appropriate quantity of caustic soda solution 3 to the mine water 2 to be worked up (of the respective (fractionation) stage).

As FIG. 1 shows, fractionated metal precipitation 21, 22, 23 initially takes place in a first metal precipitation at a pH of approximately 3.8, causing iron 5 to be precipitated as a hydroxidic iron compound 8.

The effluent of the first fractionation stage is fed to the second metal precipitation, i.e. the second metal precipitation, in which, at a pH of approximately 4 to 4.5, aluminum 6 is precipitated as aluminum hydroxide 9.

The resulting effluent is passed on to the third metal precipitation where, at a pH of approximately 8, copper 7 is precipitated as copper hydroxide 10.

These metals 5, 6, 7, iron 5, aluminum 6 and copper 7—precipitated in the fractionated metal precipitation 21, 22, 23 as metal hydroxides 8, 9, 10, hydroxidic iron compounds 8, aluminum hydroxide 9 and copper hydroxide 10,—are re-used 27 by selling them to the industry as valuable resources.

Sequentially following metal precipitation 21, 22, 23, the now metal-free effluent 30 is fed to the gypsum/sulfate precipitation 24 (sequenced metal-gypsum/sulfate precipitation).

For this purpose, milk of lime 4 which is obtained 54 by admixing water 50 to burnt lime or slaked lime or another hardness-producing precipitation chemical 19 is added 14 to the effluent 30 from the fractionated metal precipitation 21, 22, 23 (gypsum or more specifically sulfate precipitation 24).

The precipitated, metal-free gypsum 16 is extracted as harmlessly disposable sludge and fed to a dewatering unit 28.

The next process, as shown in FIG. 1, is the concentration 43 of the effluent 32 from gypsum precipitation 24 or more specifically the concentration 43 of the gypsum solution using pressurized membrane filtration 40, here nanofiltration 41, 41, by a membrane filtration system.

Said membrane filtration system comprises a membrane filter module having a plurality of disk-shaped parallel membranes.

As a membrane method 40, nanofiltration 41 is, among other things, selective for the isolation of monovalent ions in the permeate 33 and polyvalent ions in the concentrate 34.

The residual sulfate content in the effluent 32 of the gypsum precipitation 24 as determined by the solubility equilibrium is concentrated—in the concentrate 34—by permeation of the solvent and retention of polyvalent ions in the nanofiltration 41 via the solubility equilibrium and fed back 44 (recirculated) into the gypsum precipitation 24 in which gypsum precipitation is re-initiated.

As a result, the amount of lime suspension 4, as compared to the conventional lime treatment method, can be reduced as a function of the sulfate content.

The permeate 33 of the nanofiltration 41 is an alkaline aqueous solution which is dominated by the monovalent ions of the metal precipitation reagent 3, e.g. by Na⁺and OH⁻ ions. Further monovalent ions result from the composition of the mine water 2 to be worked up and reduce the quality of the alkaline aqueous solution as a recovered metal precipitation concentrate 3 which can be returned to the metal precipitation after quality-dependent mixing 29 with “fresh” caustic soda solution.

As FIG. 1 shows, for this purpose the effluent 32 from the gypsum precipitation 24 is first fed to the membrane filter module under pressure, in particular in the range 10 to 30 bar.

In the membrane filter module, the effluent 32 undergoes pressurized nanofiltration 40, 41, wherein the effluent 32 flows through the membrane filter module in a predominantly turbulent manner. Alfalaval type NF99 nanofilter membranes are used as membranes.

Depending on the composition of the mining-influenced mine water 2 being treated, the permeate 33 of the nanofiltration 41 passing through the membrane is a caustic soda solution with impurities due to monovalent ions, e.g. chloride.

Depending on quality, this recovered caustic soda solution 33 has fresh lye 29 added and is returned to the metal precipitation 21, 22, 23.

The residue passing through the membrane forms the obtained concentrate 34 which is fed back 44 into the gypsum precipitation 24, causing concentration 43 of the sulfate 17 or more specifically of the gypsum solution.

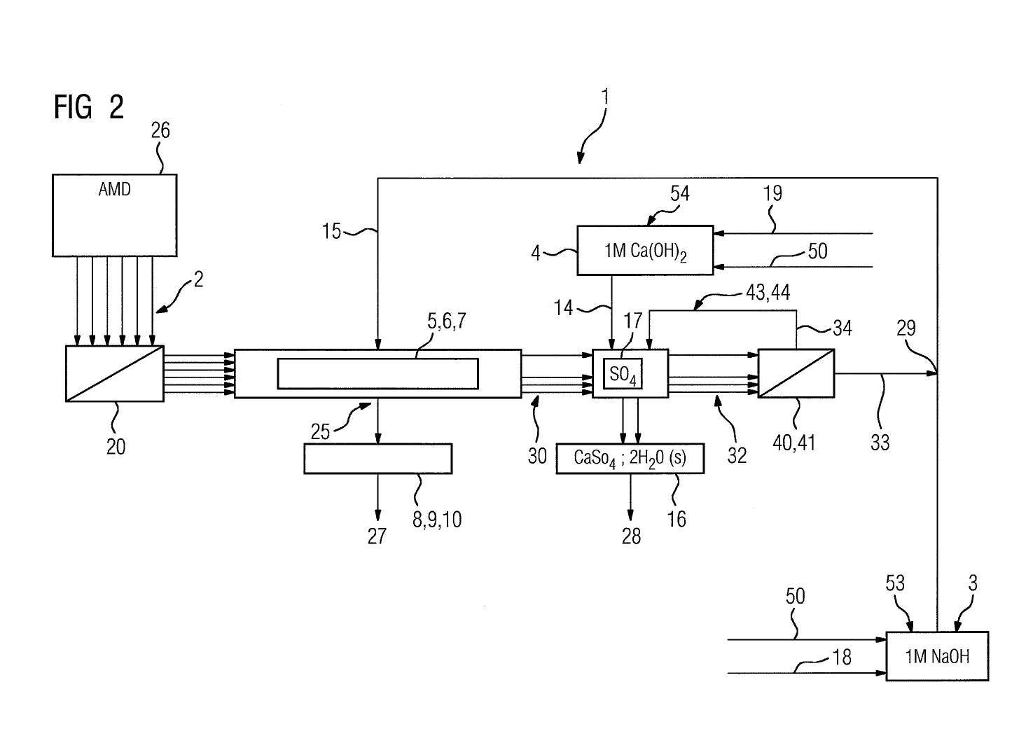

FIG. 2 shows a second procedure 1 of a method for working up mine waters 2 by sequential metal 25 and gypsum precipitation 24.

The same reference characters as in FIG. 1 are used to denote identical elements.

This second procedure 1 as shown in FIG. 2 differs from the first procedure 1 as shown in FIG. 1 only in that here—instead of fractionated metal precipitation 21, 22, 23—this metal precipitation 25 is performed by a single metal precipitation step.

The metal precipitation chemical 3, i.e. caustic soda solution, is added 15 to the mine water 2 to be worked up—the pH having been adjusted to approximately 8—causing all the metals 5, 6, 7, such as iron 5, aluminum 6 and copper 7, to be simultaneously precipitated 25 as corresponding hydroxides 8, 9, 10 in this single metal precipitation step.

The effluent 30 of the metal precipitation 25 is then likewise fed—sequentially—to the gypsum precipitation 24. This is again followed by concentration 43 of the gypsum solution and recovery of the caustic soda solution 29.

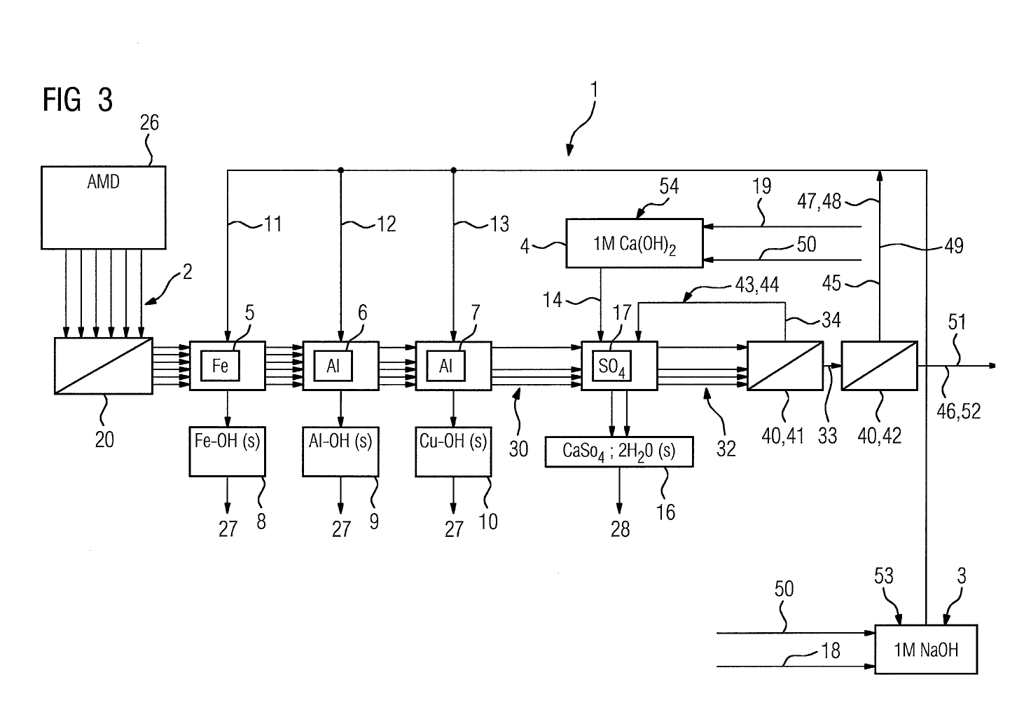

FIG. 3 shows a third procedure 1 of a method for working up mine waters 2 by sequential metal 21, 22, 23 and gypsum precipitation 24.

The same reference characters as in FIGS. 1 and 2 are used to denote identical elements.

This third procedure 1 for working up mine waters 2 essentially corresponds to the procedure 1 as shown in FIG. 1, wherein once again metal precipitation 21, 22, 23 takes place in the same fractionated manner—in three sequential processes.

This fractionated metal precipitation 21, 22, 23 is likewise followed by sequential gypsum precipitation 24 with subsequent concentration 43 of the gypsum solution by nanofiltration 41.

As FIG. 3 also shows, the nanofiltration 41 is followed by another pressurized membrane filtration 40 in the form of a reverse osmosis 42 to which the permeate 33 of the nanofiltration 41 is fed.

As FIG. 3 shows, the concentrate 34 of the nanofiltration 41 is used 44 as usual for concentration 43 of the gypsum solution.

This subsequent reverse osmosis 42 is used for or rather brings about, as FIG. 3 shows, the concentration 48 of the caustic soda solution 3.

As a membrane method, reverse osmosis 42 is among other things selective for the separation of monovalent and polyvalent ions. The metal precipitation chemical 3, i.e. the caustic soda solution, or rather its (monovalent) ions, e.g. Na⁺and OH⁻, is/are concentrated—in the concentrate 45—by permeation of the solvent and retention of monovalent ions in the reverse osmosis 42 via the solubility equilibrium and returned 49 to the metal precipitation 11, 12, 13 (recirculated) in which metal precipitation 21, 22, 23 is re-initiated.

With this recovery 47 of the zero-hardness, alkaline reagent 3 or more specifically the caustic soda solution by the concentration 48 thereof, the increased costs due to using the caustic soda solution 3 are again offset.

The permeate 46 of the reverse osmosis 41 thereafter constitutes water in drinkable quality or rather fresh water 52 which is separated off 51 in order to remove water from the circulation, thereby preventing the settling tank from overflowing due to constant accumulation of water in the process circulation.

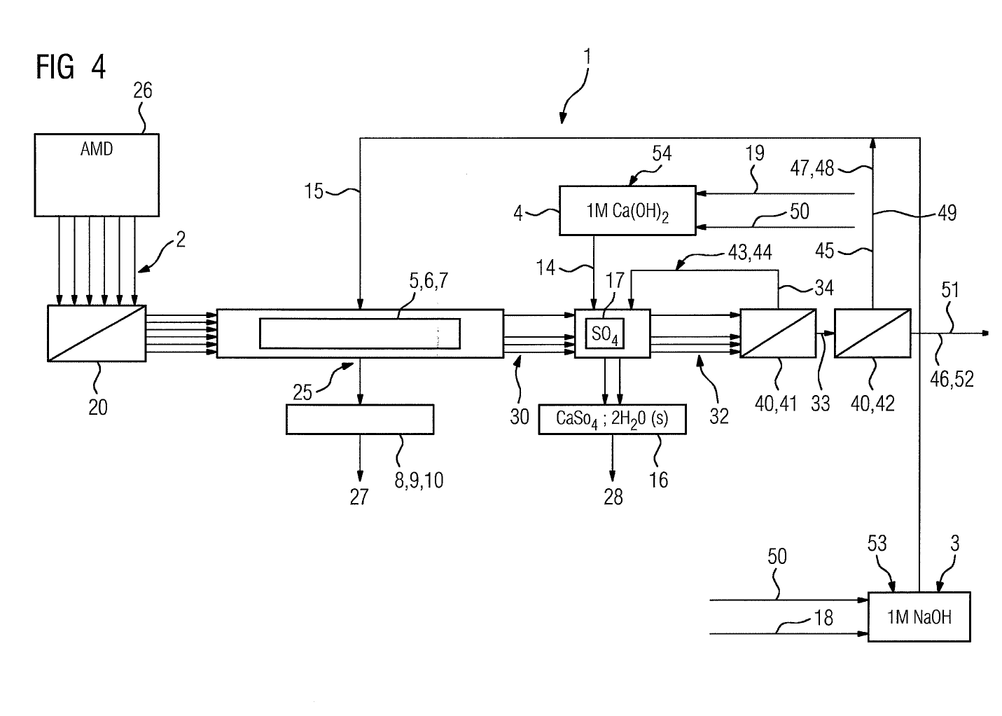

FIG. 4 shows a fourth procedure 1 of a method for working up mine waters 2 by sequential metal 25 and gypsum precipitation 24.

The same reference characters as in FIGS. 1 to 3 are used to denote identical elements.

The procedure 1 as shown in FIG. 4 differs from the third procedure 1 as shown in FIG. 3 only in that here—instead of fractionated metal precipitation 21, 22, 23—this metal precipitation 25 is performed by a single metal precipitation step.

The metal precipitation chemical 3, i.e. caustic soda solution, is added to the mine water 2 to be worked up—the pH having been adjusted to approximately 8—causing all the metals 5, 6, 7, such as iron 5, aluminum 6 and copper 7, to be precipitated as corresponding hydroxides 8, 9, 10 in this single metal precipitation step.

The effluent 30 of the metal precipitation 25 is then likewise fed—sequentially—to the gypsum precipitation 24. This is again followed by concentration 43 of the gypsum solution by nanofiltration 41 and concentration 48 of the caustic soda solution 3 by reverse osmosis 42. Fresh water 52 is here likewise removed 51 in order to prevent the tank from overflowing.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-15. (canceled)

16. A method for working up mine waters, comprising:
adding a zero-hardness, alkaline reagent at least once to a mine water to be worked up, causing metals to be precipitated as hydroxides from the mine water to be worked up,
separating the precipitated metal hydroxides from the mine water to be worked up that has initially been treated at least once with the zero-hardness, alkaline reagent, and
treating the mine water to be worked up that has initially been treated at least once with the zero-hardness, alkaline reagent and has been separated from the precipitated metal hydroxides further, by
adding a hardness-producing reagent to the mine water to be worked up that has initially been treated at least once with the zero-hardness, alkaline reagent and has been separated from the precipitated metal hydroxides, thereby precipitating a sulfate as gypsum from the mine water to be worked up that has initially been treated at least once with the zero-hardness, alkaline reagent,
carrying out membrane filtration for an effluent of the gypsum precipitation, and
feeding back a concentrate of the membrane filtration into the gypsum precipitation for sulfate concentration, and feeding back a permeate of the membrane filtration into the metal precipitation.

17. The method as claimed in claim 16, wherein the zero-hardness, alkaline reagent is selected from the group consisting of a zero-hardness lye, a caustic soda solution, and a caustic potash solution.

18. The method as claimed in claim 16, wherein the zero-hardness, alkaline reagent is added only once to the mine water to be worked up.

19. The method as claimed in claim 16, wherein the zero-hardness, alkaline reagent is added several times in succession to the mine water.

20. The method as claimed in claim 16, wherein, in the case of the repeated addition of the zero-hardness, alkaline reagent, the pH ranges respectively set in the mine water increase.

21. The method as claimed in claim 16, wherein the hardness-producing reagent is selected from the group consisting of a lime-containing reagent, a lime-containing suspension, a lime suspension, a slaked lime suspension, and a milk of lime.

22. The method as claimed in claim 16, wherein, for an effluent of the gypsum precipitation, carrying out at least one of a pressurized membrane filtration, a nanofiltration or a reverse osmosis.

23. The method as claimed in claim 16, wherein for a gypsum precipitation effluent, carrying out a nanofiltration and then a reverse osmosis using a permeate of the nanofiltration.

24. The method as claimed in claim 23, wherein, with reverse osmosis being carried out, the zero-hardness, recovering an alkaline reagent is recovered as a concentrate of the reverse osmosis from a permeate of the nanofiltration.

25. The method as claimed in claim 24, wherein, with reverse osmosis being carried out, carrying out concentration of the zero-hardness, alkaline reagent, and feeding back the concentrate of the reverse osmosis into the metal precipitation.

26. The method as claimed in claim 16, wherein a gypsum precipitated during gypsum precipitation is disposed of or used as a filler material.

27. The method as claimed in claim 16, used for fresh water preparation, wherein fresh water is separated off from the mine water to be purified.

28. The method as claimed in claim 27, wherein the separated fresh water is re-used as a fresh water source or in a mining operation producing the mine water.

29. The method as claimed in claim 28, wherein at least some of the separated fresh water is used for producing the lime-containing reagent or producing the zero-hardness, alkaline reagent.

30. The method as claimed in claim 16, wherein the membrane filtration is a nanofiltration.

31. The method as claimed in claim 18, wherein the addition of the zero-hardness, alkaline reagent takes place such that, by the addition thereof, a predefinable pH range is set in the mine water to be worked up, at which set pH range a plurality of metals are simultaneously precipitated from the mine water to be worked up.

32. The method as claimed in claim 19, wherein each addition of the zero-hardness, alkaline reagent takes place such that, by the addition thereof, in each case a predefinable pH range is set in the mine water to be purified, at which respective set pH range metals are selectively precipitated from the mine water to be worked up.

33. The method as claimed in claim 26, wherein the gypsum precipitated during gypsum precipitation is disposed of or used as a filler material in a mining operation.

34. The method as claimed in claim 27, wherein the fresh water is a permeate of a reverse osmosis.

35. The method as claimed in claim 28, wherein the separated fresh water is re-used for making process or dressing waters.

36. The method as claimed in claim 29, wherein the lime-containing reagent is the lime or slaked lime suspension.
